(19) United States
(12) Patent Application Publication
(10) Pub. No.: US 2006/0010764 A1
(43) Pub. Date: Jan. 19, 2006

(54) Fishing lure having snap-on cover

(76) Inventors: Brian P. Frawley, Mechanicsburg, PA (US); Rose A. Frawley, Mechanicsburg, PA (US); Mark A. Frawley, Coopersburg, PA (US); Carol Frawley, Coopersburg, PA (US)

Correspondence Address: Mark A. Frawley, 1029 Primrose Lane, Coopersburg, PA, 18036, US

(21) Appl. No.: 10/891,315

(22) Filed: Jul. 14, 2004

(51) Int. Cl. A01K 85/00

(52) U.S. Cl. 43/42.09; 43/42.47

(57) ABSTRACT

A fishing lure includes a crankbait body and a cover. The cover has a color or design which differs from that of the crankbait body, so that installation of the cover effectively changes the appearance of the crankbait body. The cover includes a shell that is vacuum formed over the crankbait body, so that the cover is resiliently held over that body. The cover also includes cut-outs defining side flaps which become engaged with a dive bar of the crankbait body, when the cover is attached to that body. The cover is therefore unlikely to become dislodged during the rigors of fishing, yet is can be easily removed by hand, by twisting the cover so that the flaps become disengaged from the dive bar. The invention substantially simplifies the process of changing the effective color or design of a crankbait, and reduces the expense of doing so.

### BACKGROUND OF THE INVENTION

The present invention relates to the field of fishing, and provides a cover for a fishing lure which can be quickly and easily installed or removed.

A fishing lure typically includes a crankbait, which is a body having the shape of a small fish. The crankbait is designed to resemble a fish, so as to entice larger fish to bite. The term “crankbait” is used because, when the fish bites, the angler “cranks” the reel, causing the line to be drawn in towards the angler.

It is known, from the experience of fishermen, that fish respond to the color of the crankbait, and are more likely to bite a crankbait having one color instead of another. However, the color that is most favored will change from day to day, and from one location to another, so it is not possible to know, in advance, what color will be optimum. Moreover, the optimum color may be affected by weather conditions, or by the degree of clarity or murkiness of the water. The murkier the water, the brighter the color of the bait required. For clear water, it may be necessary to use a shiny bait. Often, the angler is not sure of the proper color to be used on a particular day, and may need to try many different colors before achieving a bite. The determination of the optimum color and/or design can become a lengthy trial and error process.

It is important to use a crankbait having an optimized color, because doing so substantially increases the angler's yield. Optimizing the color of the crankbait is especially important in the field of sport fishing, where the goal is to catch as many fish as possible in a given period of time.

One solution to the above problem is simply to provide a plurality of crankbaits, each having a different size, design, and/or color. Providing multiple crankbaits will solve the above problem, but this solution is expensive. To be adequately prepared for all reasonably foreseeable needs, the angler must provide multiple crankbaits having different colors, for each size, and possibly for each different design. Thus, a complete set of crankbaits, spanning all sizes, designs, and colors, will include a very large number of items. Not only is this solution expensive, but the many crankbaits take up considerable space. Moreover, it is inconvenient and time consuming to remove a crankbait from the line, and to insert another one in its place.

It has been recognized, in the prior art, that a better way to deal with the problem of optimizing the effective color of a crankbait is to provide a colored cover for the crankbait, where the cover can be inserted and removed. Thus, a single crankbait can be used, and its appearance altered by changing the cover. Examples of patents describing this concept are U.S. Pat. Nos. 4,697,378 and 6,393,757, the disclosures of which are incorporated by reference herein.

A major disadvantage of the fishing lures shown in the above-cited patents is in the difficulty of changing the crankbait covers. It is important to an angler to be able to change the effective color of a lure very quickly. The angler usually does not want a device that has a large number of parts to be changed, but needs something simple and rapidly convertible. As noted above, this issue is especially important for sport fisherman, who seek to catch as many fish as possible within a limited period of time. For such uses, it is imperative that the changing of the lure be accomplished very quickly.

The present invention provides a fishing lure which overcomes the above disadvantages. The lure of the present invention includes a cover that can be very quickly and easily attached to, or removed from, a crankbait. The lure of the present invention has only two parts, and requires no special fastening devices to attach it to the crankbait. The lure is economical, because multiple crankbaits need not be purchased. The invention enables the angler to change the appearance of the crankbait without untying the fishing line. The lure is also pleasing in appearance, and is sufficiently sturdy to withstand the rigors of fishing.

### SUMMARY OF THE INVENTION

The present invention includes a crankbait body, having the general shape of a fish, and at least one cover which is attachable to the crankbait body. The cover has an appearance which is different from that of the crankbait body, so that installation of the cover effectively changes the appearance of the crankbait body.

The cover preferably comprises a generally hollow plastic shell, vacuum formed over the crankbait body, so that when the cover is inserted over the crankbait body, it becomes resiliently affixed to that body. Also, the cover includes cut-outs which define side flaps that become engaged with a dive bar forming part of the crankbait body.

Aside from the resilient attachment, and the engagement of the flaps with the dive bar, the cover has no other means of attachment to the crankbait body. In particular, there are no screws, nails, lugs, or other attachment devices used. The cover can be easily and quickly inserted or removed by hand, and without the use of special tools. Removal of the cover is accomplished by twisting the cover so as to disengage the flaps from the dive bar, and pulling the cover away from the crankbait body.

The crankbait body is provided with a central raised strip which closes a ventral seam in the crankbait body, and which strip has edges that are positioned to abut the edges of the cover, and thereby to minimize the seams defined by the edges of the strip and the edges of the cover.

The present invention makes it possible to change the effective appearance of a crankbait very rapidly and easily, and eliminates the need for an angler to keep a large supply of crankbaits having different colors or designs.

The present invention therefore has the primary object of providing a fishing lure having a crankbait, wherein the appearance of the crankbait can be easily changed.

The invention has the further object of reducing the cost of fishing, by eliminating the need for an angler to purchase multiple crankbait bodies.

The invention has the further object of providing a fishing lure that is convenient and easy to use.

The invention has the further object of enabling the angler very quickly to change the appearance of a crankbait, without untying the crankbait from the line.

The invention has the further object of providing a fishing lure that withstands the rigors of fishing, including the operations of casting, catching, and reeling in the catch.

The invention has the further object of providing a fishing lure which is visually appealing to the angler.

The invention has the further object of increasing the speed with which an angler can catch various fish, by providing a quickly changeable lure.

The invention has the further object of providing a fishing lure which is easily stored.

The reader skilled in the art will recognize other objects and advantages of the present invention, from a reading of the brief description of the drawings, the detailed description of the invention, and the appended claims.

### BRIEF DESCRIPTION OF THE DRAWINGS

FIG. 1 provides a perspective view of a modified crankbait body, comprising one of the two components of the present invention, and showing fishing lines and hooks attached.

FIG. 2 provides an exploded perspective view, showing the attachment of the cover of the present invention to a crankbait body.

FIG. 3 provides another exploded perspective view of the cover and the crankbait body, of the present invention, and showing the components from a perspective that shows the bottom sides of the cover and the crankbait body.

FIG. 4 provides a front view illustrating the attachment or removal of the cover, of the present invention, from the crankbait body.

FIG. 5 provides a perspective view showing the cover of the present invention while being attached to a crankbait body.

### DETAILED DESCRIPTION OF THE INVENTION

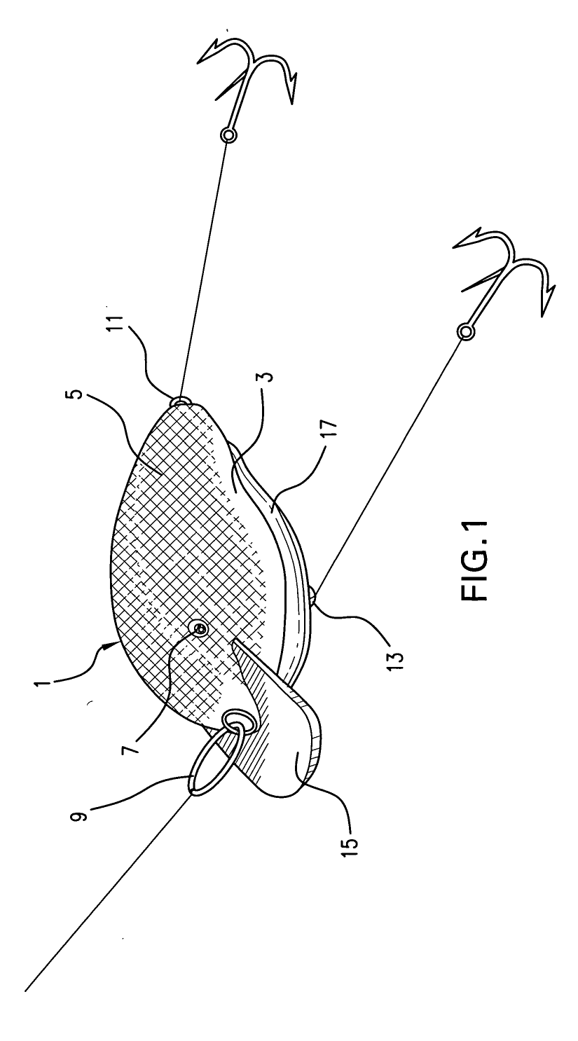

The fishing lure of the present invention has two parts, a modified crankbait body, and a cover or jacket. FIG. 1 shows the modified crankbait body, attached to fishing lines and hooks.

As shown in FIG. 1, the crankbait body 1 includes a generally fish-shaped body portion 3, the body portion having suitable markings 5, such as markings that imitate scales of a fish, as represented by the cross-hatching in the figure. The body portion also has eyes 7, one of which is visible in the figure. The crankbait body includes front ring 9, rear ring 11, and bottom ring 13, for attachment of lines and hooks as shown. The crankbait body also includes dive bar 15, at its “head” or “nose” portion. The dive bar is also known in the art as a dive plate. The purpose of the dive bar is to stabilize the crankbait body in the water, and to control the depth to which the crankbait body becomes submerged in the water. The end of the crankbait body opposite the dive bar is referred to as the tail portion.

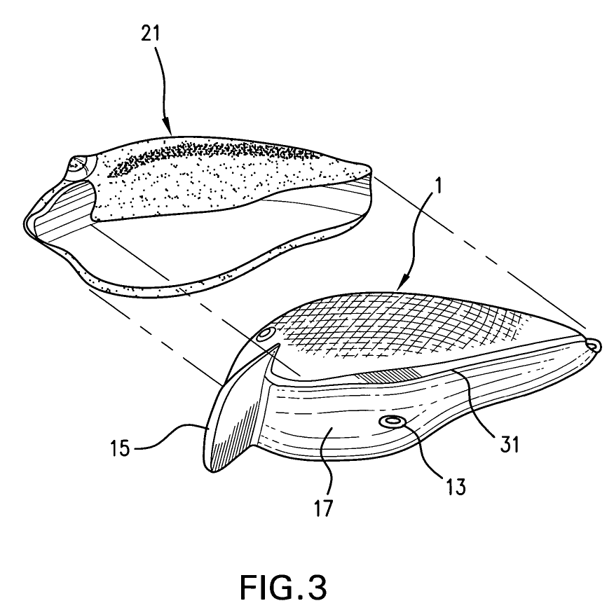

The components described so far are all found in crankbait bodies of the prior art. The crankbait body used in the present invention is modified in the following way. A crankbait body of the prior art has a seam extending along the bottom (the “belly”). That is, the seam extends along substantially the entire longitudinal axis of the crankbait body. In the present invention, the crankbait body has a central raised strip 17, which is partly visible in FIG. 1, and which is shown more fully in FIG. 3. The strip 17 effectively eliminates the seam present in prior art crankbait bodies.

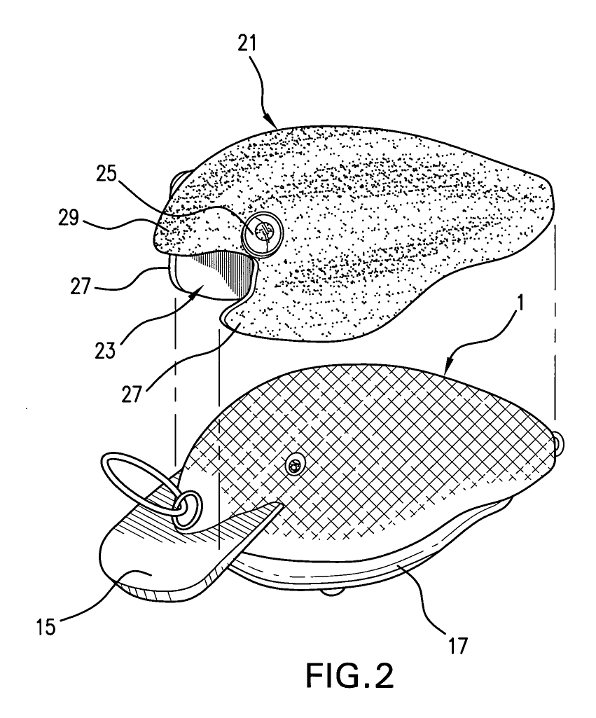

As stated above, the fishing lure of the present invention comprises two components, namely a crankbait body and a removable cover. FIG. 2 shows both components. Cover 21 fits over crankbait body 1, as shown in the exploded perspective view of FIG. 2. Cover 21 is preferably vacuum formed over the crankbait body, so that the cover fits tightly and resiliently over that body.

The cover includes a cut-out 23, near the eye 25 of the cover, the cut-out defining a pair of side flaps 27 and a generally triangular nose portion 29. When the cover is affixed to the crankbait body, the flaps assume a position under and around the dive bar 15, and tend to prevent the cover from becoming dislodged.

It is an important feature of the present invention that the cover 21 is affixed to the crankbait body without any means of attachment such as lugs or screws or other separate fastening means. Instead, the cover simply snaps onto the crankbait body, and remains firmly attached, grasping the crankbait body, in part due to the resilient quality of the cover, and in part due to engagement of the side flaps 27 under and around the dive bar 15.

FIG. 3 shows an exploded perspective view of the cover and the crankbait body of the present invention, showing the bottom sides of these components. This figure shows that cover 21 has the structure of a generally hollow, durable plastic shell, generally conforming to the contour of the crankbait body 1. The view of FIG. 3 also provides a more complete view of the central raised strip 17. FIG. 3 shows how the central raised strip eliminates any ventral seam in the crankbait body.

The central raised strip includes edges 31, one of which is visible in the view of FIG. 3. The edges are shaped so as to minimize the seam defined by the cover 21 and the central raised strip 17, when the cover 21 is attached to the crankbait body. Minimizing the seam limits the amount of water that may flow between the crankbait body and the cover. Too much water flow beneath the cover may cause the cover to lift away from, or fall off, the crankbait body.

The arrangement described above therefore creates tiny seams at the sides of the lure, when the cover is attached, instead of one seam at the bottom. This arrangement is more practical than having a seam on the top side. If water were to permeate the cover, it would flow out the back side, via the tail portion. If the seam were on the top side, water permeating the cover would become trapped and might sink the lure.

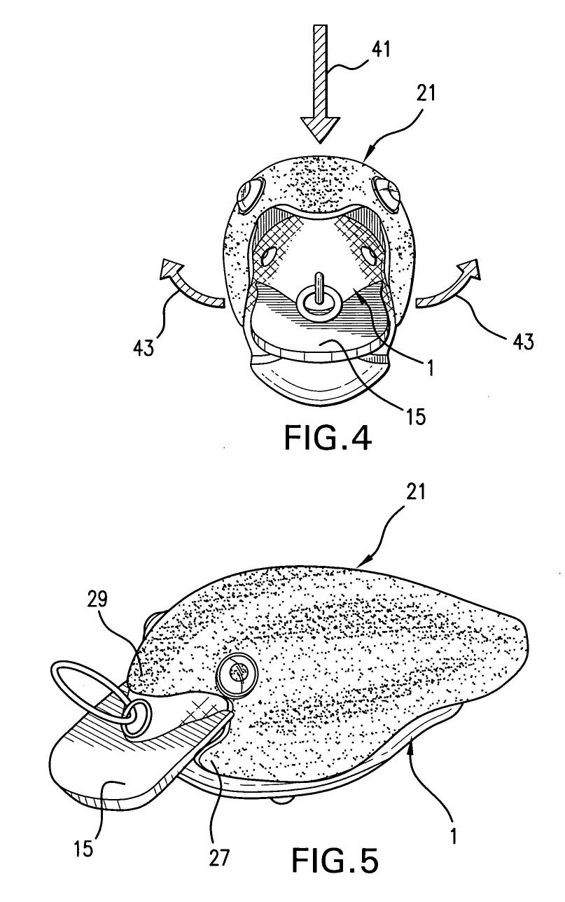

FIG. 4 provides a front view, illustrating the manner of attachment or removal of the cover 21 from the crankbait body 1. As indicated by arrow 41, the cover 21 is attached by pressing it downward onto the crankbait body 1. The cover effectively glides onto the crankbait body. The insertion procedure gives the appearance of a fish swallowing another fish. The cover can be removed by twisting and pulling the cover in the direction of the tail portion of the crankbait body. As the cover is pulled over the crankbait body, and away from the body, the side flaps tend to move in the directions illustrated by arrows 43, thereby disengaging from the dive bar, and permitting disengagement of the cover from the crankbait body.

FIG. 5 provides a perspective view of the cover 21 as it is almost fully attached to the crankbait body 1. The figure clearly shows one of the flaps 27 as it is about to engage the dive bar 15, and shows the triangular nose portion 29 about to cover the nose of the crankbait body. It is apparent, from FIG. 5, that insertion of the cover over the crankbait body effectively changes the appearance of the crankbait body, and therefore achieves the primary objective of the present invention.

The invention is not limited to the particular style of the cover. For example, the cover could be provided with additional features such as pectoral fins, to make the assembled structure more realistic. Such pectoral fins could even be designed such that they move back and forth as the lure is pulled through the water. Similarly, the cover could include a movable tail section, and/or scales that move front to back, any or all of which could be constructed to move as the lure is pulled through the water.

The cover may be provided with a color, and/or a texture, and/or a surface design, so that the effective appearance of the crankbait is substantially changed when the cover is attached. Moreover, the cover may be used to change the appearance of the crankbait so substantially that the crankbait resembles an entirely different species of fish. In the drawings of the present disclosure, the design of the cover is represented by stippling. This stippling is intended to represent virtually any possible surface design, texture, or color. What is important is that the cover effectively change the appearance of the crankbait body.

Note also that the crankbait body may itself be used as a lure, without the cover. Thus, simply removing the cover constitutes a change of appearance of the lure. The appearance of the uncovered crankbait body can be deemed one of the designs available to the angler while practicing the present invention.

The cover preferably fits perfectly, or nearly so, to the crankbait body, so that the cover does not fall off during the rigors of fishing. Specifically, it is important that the cover not fall off when the angler casts the line, or retrieves a fish. The crankbait body is preferably injection molded, but the cover is preferably made by vacuum forming instead of injection molding. Vacuum forming is preferred so as to obtain the desired degree of snugness of fit. Vacuum forming insures a substantially perfect fit, such that the cover easily snaps over the crankbait body, and does not fall off.

The cover, when formed, has the structure of a hollow shell, which permanently retains its given shape and exhibits some resilience, such that the sides and flaps of the cover can stretch outwardly as the cover is inserted or removed, and such that the sides and flaps maintain their grip around the crankbait body while the cover is attached. The plastic used to form the cover must be sufficiently durable and pliable to enable the cover to be easily attached and removed with the fingers only, i.e. without a special tool, and without distortion.

Simply pulling the cover towards the rear (relative to the crankbait body) will not suffice to remove the cover, because of the engagement of the flaps around and under the dive bar. It is necessary to accompany the pulling action with a twisting action, so as to disengage the flaps. This arrangement makes it unlikely that the cover will fall off during fishing, yet makes it easy for the angler to remove the cover when desired.

It is an important feature of the present invention that it enables the angler to change the effective appearance of a crankbait without tying a new lure to the line. The invention thus saves considerable time, making more time available for fishing. This feature is particularly important in the field of tournament fishing, where a moment lost can mean one fewer fish caught.

It is another important feature of the present invention that the resilient attachment of the cover to the crankbait body, and the engagement of the flaps around and under the dive bar, together comprise the sole means for attaching the cover to the crankbait body. Unlike the devices of the prior art, the present invention uses no screws, lugs, or other special means of attachment. The cover is held to the crankbait body by the spring force of the cover, and by the engagement of the flaps with the dive bar.

The lure of the present invention substantially reduces the cost of fishing, insofar as the angler needs to purchase only one crankbait body, or possibly one crankbait body corresponding to each size of lure. But the angler can purchase a wide variety of covers, having various colors and/or designs. Because the cover is only a plastic shell, it is inherently less expensive than the crankbait body, so buying multiple covers is not onerous.

The lure of the present invention also enhances the safety of fishing. With the present invention, the cover can be changed without removing and replacing any of the hooks. Excessive fumbling with a wet lure can lead to injury, as the hooks are likely to cut the angler's fingers. With the present invention, the hooks need not be disturbed.

The present invention therefore demands less manual dexterity than the lures of the prior art. The cover is changed from the top, i.e. one hand grasps the dive bar, preferably with the thumb and forefinger, while the other hand twists the cover off. Changing the cover from the top provides an additional margin of safety, as it tends to keep the fingers away from the hooks, and reduces the possibility of injury. There is also no need to remove and replace multiple parts, in order to change the cover.

The lure of the present invention is also easy to store. By using the present invention, the angler need not store as many crankbait bodies as in the prior art. Since the multiple covers do not have hooks, there are no problems due to tangling, and no need for special storage slots.

The invention is not limited by the specific shape of the side flaps 27. In the embodiment discussed above, and shown in the drawings, the side flap is defined by a cut-out 23 which has an edge formed in two segments. That is, the edge extending from the “eye” of the cover, towards the forward tip of the flap is articulated. But it is possible instead to make this edge straight and not articulated. The shape of the flap would therefore change slightly, but it would still be capable of engaging the dive bar 15 as described above. Thus, the invention can be modified by changing the shape of the flap, as long as the flap is able to engage the dive bar.

The invention can be modified in various other ways. The invention is not limited to a particular style or color of crankbait body. The configuration of hooks on the crankbait body can be varied. These and other modifications, which will be apparent to those skilled in the art, should be considered within the spirit and scope of the following claims.

1. A fishing lure comprising a crankbait body and a removable cover, the crankbait body being fish-shaped and having a nose portion and a tail portion, the crankbait body having a dive bar disposed in a vicinity of the nose portion, the cover being sized to fit over the crankbait body, wherein the cover includes means for engagement with the dive bar, wherein the engagement means comprises a cut-out which defines at least one flap positioned to fit around and under the dive bar when the cover is attached to the crankbait body.

2. (canceled)

3. The fishing lure of claim 1, wherein the cover comprises a shell having a shape which generally conforms to a contour of the crankbait body, the shell being sufficiently resilient to be affixed to the crankbait body and so as to grasp the crankbait body.

4. The fishing lure of claim 1, wherein the crankbait body has a bottom portion, and wherein there is a central raised strip extending longitudinally along the bottom portion.

5. A fishing lure comprising a crankbait body and a removable cover, the crankbait body being fish-shaped and having a nose portion and a tail portion, the crankbait body having a dive bar disposed in a vicinity of the nose portion, the cover being sized to fit over the crankbait body, wherein the cover includes means for engagement with the dive bar,
wherein the crankbait body has a bottom portion, and wherein there is a central raised strip extending longitudinally along the bottom portion,
wherein the central raised strip has edges positioned to meet corresponding edges of the cover when the cover is attached to the crankbait.

6. The fishing lure of claim 1, wherein the cover has an appearance which is different from an appearance of the crankbait body.

7. A fishing lure comprising:
a) a crankbait body, and
b) a removable cover,
wherein the crankbait body is fish-shaped and has a nose portion and a tail portion, the crankbait body having a dive bar disposed in a vicinity of the nose portion,
wherein the cover comprises a shell having a shape which generally conforms to a contour of the crankbait body and is sized to fit resiliently over the crankbait body, wherein the cover includes a cut-out which defines at least one flap positioned to fit around and under the dive bar when the cover is attached to the crankbait body,
wherein the cover has an appearance which is different from an appearance of the crankbait body.

8. The fishing lure of claim 7, wherein the crankbait body has a bottom portion, and wherein there is a central raised strip extending longitudinally along the bottom portion.

9. The fishing lure of claim 8, wherein the central raised strip has edges positioned to meet corresponding edges of the cover when the cover is attached to the crankbait.

10. The fishing lure of claim 7, wherein the size and contour of the cover, and the flap, comprise the sole means for attaching the cover to the crankbait body.

11-13. (canceled)

14. A cover for changing an effective appearance of a crankbait body, the crankbait body having a shape of a fish and having a dive bar, the cover comprising a generally hollow, resilient shell having an appearance that is different from an appearance of the crankbait body, the shell being shaped to conform to a contour of the crankbait body, the shell having at least one cut-out defining a flap, such that when the cover is attached over the crankbait body, the flap engages the dive bar, wherein a size and contour of the cover, and the flap, comprise the sole means for attaching the cover to the crankbait body.

15-17. (canceled)
